(19) United States
(12) Patent Application Publication
(10) Pub. No.: US 2006/0132481 A1
(43) Pub. Date: Jun. 22, 2006

(54) Digital image processor

(75) Inventor: Stephen David Brett, Swanley Village (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Pandora International Limited

(21) Appl. No.: 11/304,327

(22) Filed: Dec. 15, 2005

(30) Foreign Application Priority Data
Dec. 17, 2004 (GB) GB 0427823.0

(51) Int. Cl. G06F 17/00; G06T 1/00

(52) U.S. Cl. 345/418

(57) ABSTRACT

The present invention provides a digital image processing system comprising: a first workstation at which a first set of digital image data can be analysed to determine a first set of colour correction parameter data corresponding to colour corrections to be made to the first set of image data; a second workstation at which a second set of digital image data can be analysed to determine a second set of colour correction parameter data corresponding to colour corrections to be made to the second set of image data; and a digital image processing module connected to the first and second workstations so as to receive correction requests containing the first and second image data sets and first and second colour correction parameter data sets respectively from the first and second workstations, wherein the digital image processing module comprises a programmable logic device. The invention further provides a method of processing digital image data using the system of the invention.

### FIELD OF THE INVENTION

The present invention relates to image processing and more specifically, to the post-production processing of video data, especially the colour-correction of such data.

### BACKGROUND OF THE INVENTION

It has been possible for many years to digitally process picture signals representing television or film images. These images are often captured on Cinematographic Film, and transferred to Digital data through Film scanners or Telecine machines. Currently, different resolutions are used, dependant on the output media desired. Typical broadcast television at standard definition may be at a resolution of 720 picture elements by 576 active lines, refreshed at 25 frames per second. High Definition Images may be represented at 1920 picture elements at 1050 lines refreshed at 25 frames per second. Imagery for Digital film or Digital Intermediate work may be scanned at up to 4000 picture elements by 3000 lines, at 24 frames per second. Special formats for large screen presentation exist, and one such format is the IMAX format. This is usually film originated, using substantially larger than usual film. These images, when digitally stored and processed may require up to 8000 lines of information to be scanned, in order to preserve all of the detail on the film image.

This data may be treated in several ways. Television material is usually thought of as video (i.e. real time). Thus it is formatted digitally into a broadcast or video stream, which is treated synchronously, and has added end of line and end of frame synchronising codes. Typically video data also has defined start of frame information. Conversely, Digital Film images are represented more with a computer file structure than a broadcast video structure.

Typically the captured material, be it obtained by scanning Film or from a Digital Camera, will be processed. The processing will include steps such as editing and grading. The grading process, may include several actions. One action might be to lighten the image overall, to correct for the effect of under (or over) exposure of the film material in the image. Another might be to alter the amount of red in the image. A third might be to alter the reds in the image to make them redder without altering the neutral tones (which contain red) or the other colours, whether they contain red or not. Further examples may include altering the focus or sharpness of images.

The process of grading can become complex, as operators may desire to change some scenes of the material obtained, whilst leaving others alone. In the scenes to be changed, it may be desired to alter only a spatial part of a series of frames. For example it may be desirable to change the colour of the red car in a scene, whilst leaving alone the red post box (which is exactly the same colour as the car). This is usually accomplished with windows in frames, where processing is to take place within a window or outside a window. Further methods of processing may be through object recognition, where the system is clever enough (or can be taught) to recognise the difference between a car and post box. By altering parts of a scene, whilst leaving others alone, many changes can be made to a picture or scene. For example, by the subtle alteration of the sky in a picture or scene, it is possible to alter the perceived time of day that the material was shot at. Mid-day scenes can be made into late evening scenes by altering the sky colour. The number and type of overall adjustments that can be made are limited in theory only by the imagination of the operator. It can be seen that the above operations require substantial computation power to be available to process imagery at a reasonable speed. This need becomes even more critical at high resolutions such as Digital Film or IMAX resolutions.

It is also important to realise how the operators and artists involved in this workflow operate. It takes time to look at images, to decide on whether the scene looks right. Typically in grading, a film work will be broken up into scenes. These scenes correspond usually to the scenes that were shot by the Director of Photography, but in some cases they may not. For each scene, an operator will find typical frames, and look at these as still images. Operators will then go through a series of adjustments, varying the overall lightness and darkness, the overall hue, and then perhaps making secondary colour adjustments. These settings will be stored by a grading controller. Examples of such systems include the ‘POGLE’, manufactured by the applicant, or the ‘2k Plus’ system from Da Vinci, Fla., USA. Such systems can cumulatively store settings of a scene, building up a list of settings for each scene as the operator makes adjustments. After primary and secondary grading, operators then alter time dependent parameters within a scene. This may involve tracking a red car that is in the same scene as a red post box. The operator may draw a tracking box over the item to be tracked, and check that the box does indeed track the object to be changed. Alternatively he may verify that the automatic object identification does indeed identify correctly the object desired to be changed. Finally, when a scene (or group of scenes) is completed to the operators satisfaction, the overall processed scene (or group of scenes) is stored as processed (or graded) scenes. It is important to realise that for all of the adjustments that an operator makes, he wishes to see the effect of those adjustments in real time. Because there are no standard units of adjustment of any of the parameters to be adjusted, it is necessary to adjust until right, and this requires real time feedback of that adjustment.

Because of the resolution limits to present display technology, it is sometimes desirable to view the imagery at one resolution, whilst processing it at another (usually higher) resolution. For example, with IMAX material, it is unlikely to be able to be viewed on an electronic medium at anything higher than ‘2K’ resolution, whilst the digital files that will be used to prepare new film images may be at 8K. Some methods exist where it is desirable to process only the 2K ‘view’ or ‘proxy’ images, whilst later (when the operator is satisfied with the end result) processing the higher resolution (8K) images. Other methods always process the highest resolution images available, and if necessary produce a new viewable image sequence from this

It will be appreciated that the computational power required to make the types of digital image adjustments described above will vary greatly over time. When power is required, it may be for a real time adjustment of imagery up to 8K resolution, but for a substantial amount of the time operators will be looking at a still image, deciding whether it has the reproduced appearance attributes that they are searching for. At this point, no processing power is required at all. Thus relatively large amounts of processing power will be required over relatively short periods of time, very little power being required in the intervening periods.

It is also important to realise the work flow of such productions. In the production of commercials, there may be several hours of film material shot, which results in a finished commercial of only 30 seconds. A substantial proportion of this material will be graded prior to the selection of which parts are to appear in the final commercial. It is also a recognised rule of thumb that the time taken to grade a one hour feature will be typically between three and ten hours. For commercial and pop promotional work this ratio may be as much as thirty fold.

Conventionally, image processing work in the film and television industry is performed by operators that work in a dedicated room which has dedicated equipment. A Telecine suite is usually booked by the hour to a project, and during these hours the Telecine, together with the controller and colour grading equipment is solely available to the operator. Thus when the operator needs the computational power it is available. However, in view of the varying computational power required when grading feature material, in this traditional method the power of the grading systems is only effectively used a small proportion of the time. Typical facility houses that provide systems for clients work will usually have several grading or telecine rooms. Conventionally each room has its own dedicated equipment, which will consequently be used to its maximum computer efficiency only a small proportion of the time.

From a first aspect therefore the present invention seeks to provide a digital image processing system in which the computing resources used in the image processing may be used more efficiently. This is achieved by providing a centralised image processor to which discrete packets of image data may be sent together with the relevant processing instructions. One such system is described in the applicant's own earlier published patent application GB 2312129 A which discloses a remote colour processor to which image data is sent for processing together with image correction data.

### SUMMARY OF THE INVENTION

The present invention seeks to improve on this system by providing a digital image processing system which allows the processing of a number of image processing jobs at a centralised image processor to be carried out more efficiently.

An object of the invention therefore, at least in its preferred embodiment, is to provide a flexible architecture providing processing resources for digital image correction which can be implemented in a dynamically reconfigurable series of logic cells within a programmable logic device. In its preferred embodiments at least, this architecture allows the concurrent real time processing of multiple image data streams while making more efficient used of the processing resources provided than in the traditional arrangement in which each user accesses a separate colour corrector.

From a first aspect, the present invention provides a digital image processing system comprising:

a first workstation at which a first set of digital image data can be analysed to determine a first set of colour correction parameter data corresponding to colour corrections to be made to the first set of image data; a second workstation at which a second set of digital image data can be analysed to determine a second set of colour correction parameter data corresponding to colour corrections to be made to the second set of image data; and

a digital image processing module connected to the first and second workstations so as to receive correction requests containing the first and second image data sets and first and second colour correction parameter data sets respectively from the first and second workstations, wherein the digital image processing module comprises a programmable logic device.

It will be appreciated that the image processing module could be sold separately ready for use in a network of existing workstations. From a further aspect therefore, the present invention provides a digital image processing system comprising:

data connection means for connection to a plurality of workstations at which respective digital image data can be analysed to determine respective sets of colour correction parameter data corresponding to colour corrections to be made to the image data; and

a digital image processing module connected to the data connection means so as to receive correction requests containing the respective image data sets and the respective colour correction parameter data sets, wherein the digital image processing module comprises a programmable logic device.

The digital image processing module comprises a programmable logic device which is made up of a number of gates or logic cells, groups of which can be programmed to carry out different processing functions. In some instances the programmable logic device will be large enough to provide sufficient processing capacity to correct both the first and second sets of digital image data in real time. In the context of film images, real time refers to corrections being made within a frame interval. Thus it may be possible to correct the image data from both the first and second work stations and to return it to be viewed at the respective workstations within a single frame interval such that an operator would not be aware of any delay in processing.

In a preferred embodiment of the invention, the system further comprises a controller for controlling the order in which correction requests received from the respective workstations are processed at the digital image processing module. This is useful as it may not always be possible to process all the various colour corrections requested by the various workstations connected to the digital image processing module in real time. This may be true where particularly complex corrections are requested or where more than two work stations are connected to the digital image processing module.

In one preferred embodiment, the controller is configured to analyse the digital image data and the colour correction parameter data received from each work station and to determine whether or not all of the corrections can be carried out together in real time by the digital image processing module. Where the digital image processing module does not have sufficient capacity to do this, the controller can determine which sets of image data should be processed before others.

To determine which sets of image data should be processed first, the system could include means for prioritising certain corrections. Thus, in one preferred embodiment, all correction requests being forwarded by a particular work station could take priority over data from the other work stations. In an alternative embodiment, all correction requests relating to a particular film or job could take priority over other image data, irrespective of the workstation from which the image data is received. In a particularly preferred embodiment, corrections to be carried out could be prioritised based on a combination of the workstation from which they are received and the film or job to which they relate.

Preferably the controller is programmed to sort all the received correction requests which have not yet been processed according to their priority. The controller is then preferably configured to schedule the processing of the correction requests by balancing the priority of the requests against the available processing power in the programmable logic device for the requested correction.

In one embodiment, different groups of gates or cells within the programmable logic device will be programmed to carry out different colour correction functions and the controller will know that only those cells which are programmed for a particular type of colour correction are available to process that type of correction. In a preferred embodiment however, the gates or logic cells of the programmable logic device may be reprogrammed by the controller to carry out a different type of colour correction depending on the corrections requested by the various workstations. Thus for example, the programs for different types of colour correction, grain reduction and scratch concealment can be stored in the controller and loaded into an appropriate number of the gates or cells of the programmable logic device to provide the required processing power for the corrections to be run by the controller at any time.

The programmable logic device could be any semiconductor device providing individual cells of programmable logic. In one particularly preferred embodiment however, the programmable logic device comprises a Field Programmable Gate Array (FPGA). Where higher processing power is desired than can be provided by a single FPGA, a number of FPGAs can be connected together to form the programmable logic device.

In one particularly preferred embodiment, the image processing module comprises four FPGAs connected together, and the controller comprises a fifth FPGA connected to each of the other four FPGAs.

A method of processing image data using the system of the invention is also considered to be novel and inventive and so, from a further aspect the present invention provides a method of processing digital image data using the system of the invention.

From a further aspect the present invention provides a method of processing digital image data comprising the steps of receiving a plurality of image data correction requests concurrently at an image processing module, analysing the image data correction requests to determine whether or not they can all be processed concurrently in real time and determining the order in which the requests should be processed if the requests cannot all be processed concurrently in real time.

### BRIEF DESCRIPTION OF THE DRAWINGS

Preferred embodiments of the invention will now be described, by way of example only, and with reference to the accompanying drawings in which:

FIG. 1 is a schematic representation of a first system according to the invention;

FIG. 2 is a schematic representation of a second system according to the invention;

FIG. 3 is a schematic representation showing an embodiment of the invention in which data is processed reiteratively; and

FIG. 4 is a schematic representation of a number of workstations connected to a digital image processing system according to the invention.

### DESCRIPTION OF THE PREFERRED EMBODIMENTS

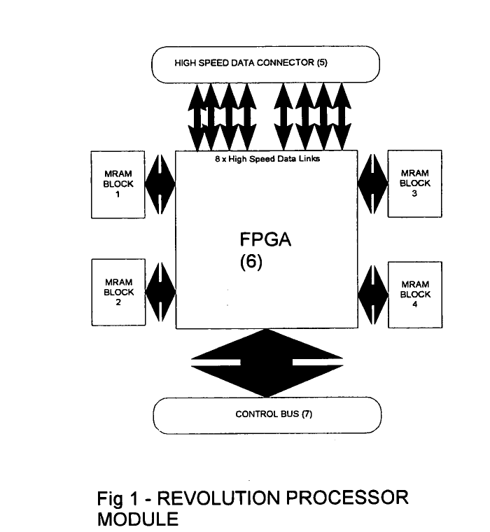

A digital image processing system according to the invention is shown schematically in FIG. 1. Digital image data to be corrected is analysed by an operator at a workstation (not shown). The operator decides on corrections to be made to the image data which are stored as an appearance attribute correction data set at the workstation. A number of workstations are connected to the image processing system by a high speed data connector 5. The high speed data connector can for example be made up of eight parallel bidirectional data links which each consist of a 3.125 Gigabit optical fibre and multi gigabit transducers and conform to the XAUI industry standard. The image data to be corrected is passed to the digital image processing system from the workstations together with the appearance attribute correction data via the high speed data connector.

The image processing system also comprises a digital image processing module made up a Field programmable gate array (FPGA) which receives the data to be corrected and the appearance attribute correction data via the high speed data connector. The FPGA is typically a Xilinix ZVP20 model obtainable from Xilinx of San Jose, Calif., USA. These devices have two power PC devices, 88 multipliers, and 20880 logic cells.

The FPGA is connected to a control bus 7 such as an Industry standard Gigabit Ethernet. Data supplied to the FPGA is stored in four memory blocks 1 to 4 connected to the FPGA. If desired, it is possible to mount the cards supporting the system of FIG. 1 into industry standard PC backplanes, preferably into backplanes that conform to the PCI Express protocol. It will further be appreciated that a number of FPGAs can be integrated on a single manageable PCB card. The cards can be replicated within a card frame rack, to form a central resource for volume grading of data. Further, it is possible to have multiple card racks, either physically connected together or connected together using appropriate computer networking technology such as the XAUI protocol, implemented over multiple optical links.

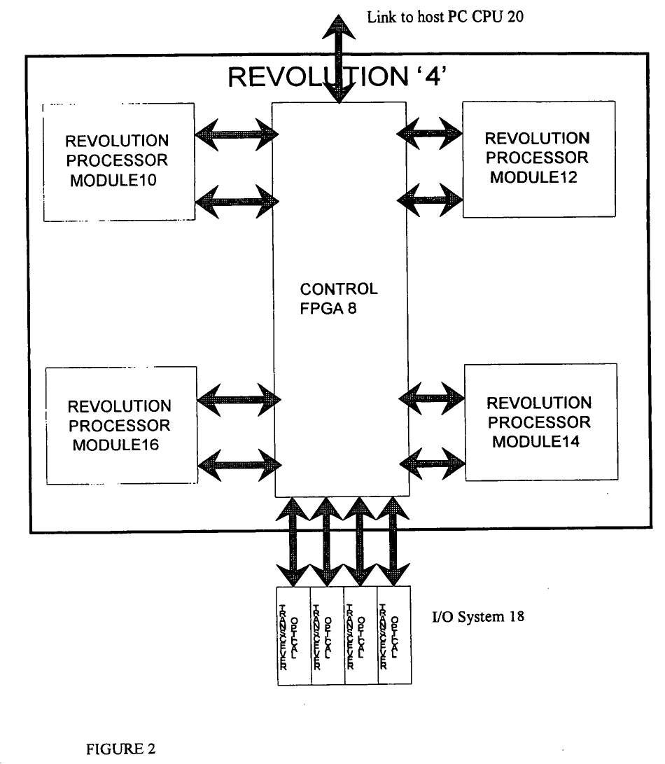

An alternative more preferred embodiment of the system of the invention is shown in FIG. 2. In this embodiment, a total of five FPGAs are provided, one of the FPGAs acting as a controller 8 and being connected to each of the four other FPGAs 10, 12, 14, 16. Digital image data to be corrected together with image attribute correction data is fed to the controller 8 via an input/output system 18 which will typically consist of multiple channels of bidirectional optical transducers as in the first embodiment. As for the first embodiment, this larger card containing 5 FPGAs can interface to industry standard PCI Express PC backplanes. Further, the control FPGA may be held in the rack of a PC computer CPU and may have a high speed link 20 for communication with the CPU.

Each FPGA comprises a number of gates or cells of logic which can be programmed to carry out different functions as required. Due to the nature of the FPGA, the processing that is carried out in the FPGA is reprogrammable. Thus if operations occur that require a given modular function, then the FPGA can be reprogrammed to contain as many of these functional blocks as needed (or as possible), and also other FPGAs on that card, other cards in that card rack, and other card racks on the network. Thus in the embodiment of FIG. 2, one function of the control FPGA 8 is to act as the reprogrammer of the FPGAs to which it is connected. This is achieved by loading stored programs from the controller into the relevant cells of the FPGA. Each correction process for which a stored program is created could be given a unique identification number. A 32 bit number could be used to provide a large range of possible identification numbers.

Another function of the controller 8 is to schedule the processing requests received from the various workstations in the form of digital image data and colour correction parameter data sets. This allows the allocation of resources as required to each job or processing request with the most important jobs (as perceived by the system being processed first) because of the requirement of providing a ‘real time’ response to certain operations. In view of the above, the applicant has developed scheduling priorities. The first class of these includes methods that are originating workstation dependant. Thus a system manager might have the ability to promote one workstation to take priority. This mode would be used for demonstrations to visiting clients, who wanted to see their work graded. In this mode, all requests coming from the designated workstation are treated as more urgent than requests coming from other workstations. The other workstations could also be designated by the system manager to have a priority number, which could be in the range of 1 (being the lowest priority) to 100 (the highest priority). The control and scheduling module 8, running to supervise the activities of the shareable resource processors 10, 12, 14, 16 would look at incoming jobs, and run them according to priority number.

A second alternative is to prioritise and schedule processing requests according to the priority of a project. This allows various movies, programs, or works to be prioritised. Thus if the system manager sets the project priority for ‘Film X’ to be high, and the project priority for ‘Program Y’ to be low, then jobs which are part of ‘Film X’ will be treated with high priority, and jobs which are part of Program Y to be low priority, no matter which terminal they originate from.

A third scheduling methodology involves the prediction of processing power compared with available time. For example, with a finite computing resource it is possible to specify occasionally a processing request that cannot be satisfied with real time response. Therefore, there is little point in using up considerable processing resources only to disappoint the operator by not providing a real time response. Therefore the controller can estimate that certain jobs or processing requests will not run real-time, even if given full access to the available hardware. These jobs are therefore lowered in effective priority by the scheduler, as since they cannot be done with real time response, they might as well be run specifically as a non real time job, using up spare processing resource when and as available, and not impinging on the processing power required for other jobs that could be processed in real time.

One important factor to appreciate is the regularity of the data provided in digital film processing. The data comes in film frames, all of which are the same (digital) size, and each frame consists of the same number of lines and pixels as every other frame. For real time processing, the time interval between frames is constant, and so the controller knows the size of the data packet which it will receive and when it will receive it.

An alternative embodiment includes the ability of clients to bid (financially) for image processing resources. Thus two production companies both wishing to complete their project at the same time may have the ability to enter bids for resources, indicating the amount that they are willing to pay. The allocation between bids can be decided on the highest bid.

In a further alternative embodiment, the controller calculates how may processes can be supported while still providing real time processing. After allocating resource on a priority (either per project, or per terminal) the system may determine that for example, out of three jobs, one low resource job can be accommodated but not either of the other two. Thus an important job of the controller when scheduling processing is to predict resource required by jobs.

Let us consider a number of jobs to be carried out by a number of users, each of which can consist of a number of operations. In one example, the digital image processing system comprises two four processor FPGAs. Each FPGA contains enough gates to carry out a number of functions, some of which may be replicated. In this example, the operations are as in the table below. Each FPGA can contain a maximum of 100 units of gates

| | Amount of logic for one |
|---|---|
| Function | implementation |
| 6 channel colour correction | 20 Units of Gates |
| Grain Reduction | 10 Units of Gates |
| Scratch concealment | 30 Units of Gates |

The controller may have received at one time, for example, 5 colour correction requests, of 10, 20, 30, 40 and 50 frames respectively each from low priority users. These are for low priority projects. (These are given Job IDs as 1,2,3,4,5 respectively)

There has also been a request from one high priority user who wants to carry out a 12 channel colour correction (12 separate colour correction functions to be carried out on the same digital image data) on 100 frames (This is given Job ID 6)

The final request received is from a low priority user with a project of high priority that wishes to carry out scratch concealment on 50 frames. (This is given Job ID 7)

The Job requests will contain a header. Whilst there are many forms that this header can take, one typical form may be
Unique Job ID
Priority of user
Priority of job
Number of frames to be processed
Code to determine job type (colour correction, grain reduction, scratch concealment etc.)

There will exist on each processor board a configuration table that will contain a data structure.

A Typical structure for a board may be

| | |
|---|---|
| Processor Number | Number of Units of gates in that |
| | processor |
| Processor Number | Number of Units of gates in that |
| | processor |
| Processor Number | Number of Units of gates in that |
| | processor |

Typically after all of the processors have been numbered, together with their capacity, the table may contain a zero or null, to signify that no further processors exist on that board. Thus a ‘one processor’ card (such as Pandora International's Revolution Solo) may only contain one line, followed by a null. As stated above, the processors will typically be FPGAs although they could also be other suitable types of programmable logic devices.

The scheduling task, implemented in software code in the controller, will carry out the following steps.

Firstly an initial ‘priority sort’ will be carried out for all jobs currently requested. Typically the sum of the job priority and the user priority will be used as the primary sort parameter. Thus the controller will sort requests into

High Priority users with High Priority projects

High Priority users with low Priority projects/Low Priority users with high priority projects

and so on until reaching

Low Priority Users with low priority jobs

Note that a further improvement in this initial ranking may be to weight the users and jobs with further constants.

For example, initial priority may be derived from =a x (user priority) +b x (project priority)

Where a=b=1, this example reduces to the simple case above. If it is desired to weight on the user rather than the project, a can be set to, for example, 2. This will have the affect of ranking

a low priority project submitted by a high priority user higher than a high priority project submitted by a low priority user

From this first priority ranking, an initial scheduling exercise can be carried out. Let us assume that in this, an initial ranking has been produced of

Highest priority—High Priority user who wants to carry out 12 channel colour correction on 100 frames (Job ID 6)

Medium priority—Low priority user with high priority project wanting to do scratch concealment (Job ID 7)

Low priority—the 5 users with low priority jobs with Job IDs of 1, 2, 3, 4, and 5

The initial scheduling of this list involves looking at the Hardware table entries, from which it can be seen that each of the eight FPGAs contains (for example) 100 units of gates.

One first approximation schedule may be to load every FPGA with the most important functions (derived from the highest priority job—in this case a 12 channel colour correction. Thus the controller might consider loading 5 (6 channel) colour correction functions into every FPGA, giving us 5×8=40 units of colour correction. These may be cascaded, so that 20 of the units carry out the first six channels of correction, whilst the other 20 blocks carry out the next 6 channels of colour correction. The controller can model the time taken to carry out this job in this manner, knowing that it takes one frame cycle (for example) to load all of the FPGAs in this manner. There may be a frame buffering cycle needed to read out the data from the first corrections to be read back in for the second corrections. An alternative way of doing this is to model the reiterative process of each of the 40 units taking two cycles to process the data ‘in situ’ giving the affect of accomplishing 12 channel correction. The time taken to communicate inter board (between the two boards each of 4 FPGAs) is known.

Continuing this pattern, the running of the next highest priority job is then modelled in the same manner. Eventually a total time for all of the jobs to be completed would be worked out. Note that completing all requests in a minimum of time is useful but may not be the sole determining factor. It is important to provide the right response to users, dependant on their project and importance. Thus an equivalent overall time may be determined, from the addition of the equivalent process times. This equivalent process time may be calculated from actual process time that is weighted by the priority order. Thus a high priority request that gets done last would give an equivalent overall time that was longer than the same individual processes where the high priority job was competed earlier. Many other calculation processes exist to produce indices of optimisation and overall user satisfaction. Usually a system administrator would be expected to set these parameters on installation, and tune them to maximise satisfaction and performance.

This interaction would then be run with different assumptions. For example, if two jobs of priorities that are similar (say within a few arbitrary units) are swapped, then does this affect the overall run time for all jobs drastically? (Note that if it prevents undesirable reloads, say from colour correction from job 1, to scratch concealment for job 2, and back to colour correction for job 3, if jobs 2 & 3 are of close priority it may be desirable to swap their execution order.)

The number of blocks to be replicated can be experimentally analysed by the system. For example, if the top job really is much higher in priority than other jobs, it may be beneficial to give this job all the available processing resources. However the difference in relative priorities may determine the split of resources. For example, if two jobs of different function have relative priorities of 60 for the highest and 40 for the second highest, this may cause calculation of run times with an assumption that 60% of the overall resources get allocated to the first function, with the remaining 40% are used for the second function.

It is generally desirable to double and/or half these assumptions to see how this affects the results obtained. Thus it is useful to search for empirically optimal solutions by determining what would happen if one process gets twice as much resource, or half the amount of resource. Trends can be spotted, and modification factors can be chosen between the double and half factors.

It is important to realise that there is probably no deterministic method to calculate exactly which order it is best to process requests in. Therefore as many alternatives as possible should be modelled with the above logic to see when the best solution for fit of jobs between processes, processors, users, and projects is obtained.

In an alternative embodiment of the invention, a controller could be provided in each of a number of FPGAs making up the digital image processor. In this embodiment, the FPGAs could negotiate with each other as to which FPGAs should carry out which corrections.

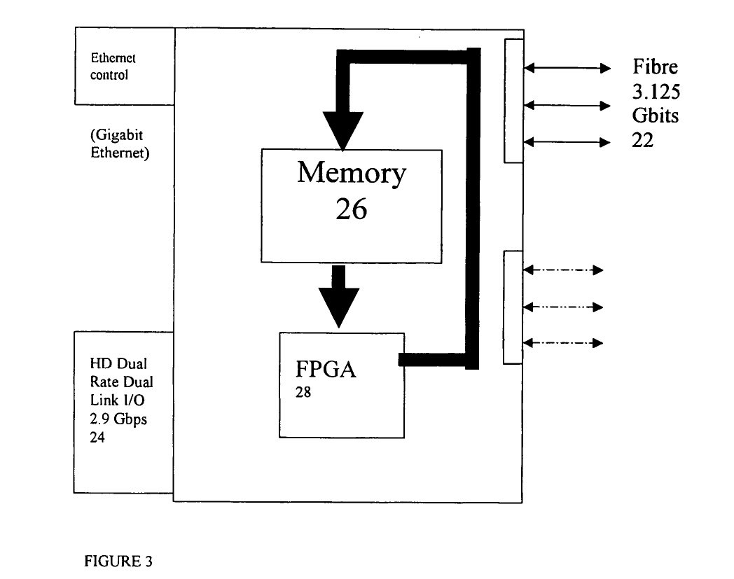

The applicant has also realised that it is desirable to reiteratively process images to obtain certain results. Thus the architecture and image flow in one embodiment of the digital image processing system of the invention can be reiterative. This is illustrated in FIG. 3, where data is taken in from external sources, either via Industry standard Fibre Interfaces (XAUI) 22, or via HD Dual Rate Dual Link I/O 24. This data is stored in Memory 26. This memory is read into the FPGA 28 where it is processed, and written back to Memory 26 again. This iterative path allows either reiterative algorithms to be run (for example Gaussian Pyramid algorithms) or for successive unrelated algorithms that an operator has specified to be performed. It is desirable to perform, if possible, all operations required on a given set of data at one time, as this minimises the Input/Output overheads and raises efficiency.

The rate of increase of the number of gates within available FPGAs seems unstoppable. There are likely to be FPGA components with 20 to 50 Million gates available within the next few years. One thing that is likely to limit the uptake of these devices is that applications are unlikely to require such processing capacity. A further limiting factor is the coding of FPGAs of such size and complexity of application. In one implementation, instead of the embodiment of FIG. 2 in which the processing power is spread out amongst five physical devices, all of the processing functionality could be programmed into a single sufficiently large FPGA. In another implementation, it might be possible to incorporate multiple blocks of the processing logic into a single FPGA.

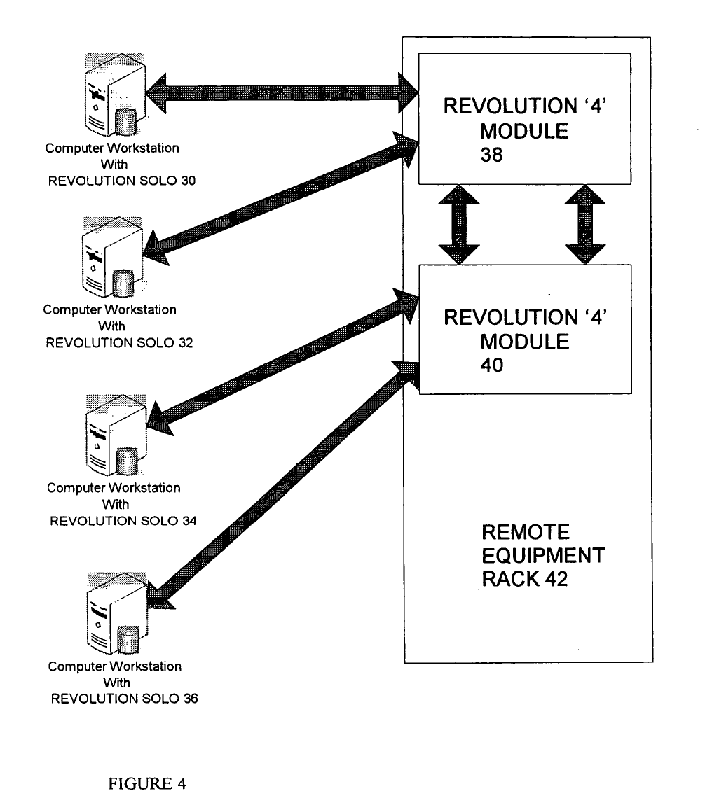

The benefits to a multi-user system of digital image processing system are illustrated with respect to FIG. 4. In FIG. 4 there are four workstations (30, 32, 34, 36), each with an operator working on them. These workstations preferably contain FPGA processors, for local work. The operators will perform grading and other operations on material that is local to them. In some cases, it may be desirable to perform a grade on a given key frame (or a limited number of key frames) from a scene. This could be performed locally at the workstation on this frame, or on a limited number of frames. It may be desirable that when the operator is satisfied with the resultant look on the key frames, he then wishes to process the whole scene. Whilst it may be possible to perform this on his terminal, he may wish to be looking at the next scene. Therefore to aid productivity, the repetitive processing of a complete scene may be better carried out on a remote digital image processing system according to the invention (as represented by the FPGA modules 38, 40) in a remote equipment rack 42 which are shared by all users. Alternatively, if the image processor at one of the other workstations is idle, an image processing request from a first workstation could be processed at that idle workstation.

To enable the embodiment of FIG. 4, two forms of intelligence are required. Firstly it is necessary to have a load manager/scheduling task running on each workstation. Secondly it is also necessary to have a load manager/scheduler (i.e. the controller of the invention) on the central modules, and these two load managers are required to communicate. On one level the load manager at the terminal looks at the request for processing. If it exceeds the processing power available locally, this request is passed over to the load manager/scheduler at the central resource. This calculates, based on the current and predicted load, the time required to process the requested job. This is then communicated back to the local load manager/scheduler, and if the time required quoted by the central load manager/scheduler is within a set of user defined parameters, then the two load managers agree that this will be carried out on the central system. Note that if the time required is outside the user set parameters, it probably means it would be quicker to get the processing done locally on the user's terminal. Note that as described above the load manager/scheduler will take into account the priorities of both the originating terminal and the project priority in determining the required time.

On another level, a scheduling task at each FPGA will continue to monitor the requests for processing put upon it. One option is that these local schedulers will also investigate the predicted efficiency if the FPGA is reloaded with a different combination of processing cores. For example, an FPGA may be programmed to contain three channels (or modules) of colour correction, together with three channels (or modules) for blur. If the requested task is primarily colour correction, it may be advantageous to reload the FPGA with six (or the maximum number available) of channels/modules of colour correction at the expense of the blur which is not being used. The disadvantage is that reloading the FPGA takes a finite overhead time, which must be factored into the equation as to whether it is quicker to reload and process more efficiently, or whether it is quicker to accept the slower processing without the reloading overhead. Note also that in some cases it will be possible for the scheduler for a given FPGA on a multi-FPGA PCB to negotiate with its neighbour about sharing resource. This would be preferably carried out through (or by) the control FPGA.

On a higher system level, it is also possible to share resources, by an extension of the above methods, between multiple multi- FPGA PCBs, and also extend to multiple remote equipment racks.

Although the invention has been described in terms of FPGAs, many other processing technologies could be used in the same way. These technologies include the ASP (Associative String Processing) technology from Aspex Semiconductor Ltd, of High Wycombe, Buckinghamshire, United Kingdom. The Aspex Linedancer chips currently contain 4096 single bit logic cells. Other technologies that could be used to implement the systems that have been described include components from Stream Processors Inc, of Stanford, Calif.

In summary, the present invention at least in its preferred embodiments provides an image processing architecture never seen before in the Digital Film/Post production area, where multiple FPGA processing is taking place on a number of processors, for a number of users. This balance between the users, their jobs, and the function of the FPGAs changes dynamically with respect to the demands placed on the system. The system is dynamically reconfigurable, and scaleable. It features Multiple High speed network connections, with large image buffers at each node. A key feature is the software architecture which controls the system. This runs preferably on the PC that the PCB carrying the FPGAs slots into.

What is claimed is:

1. A digital image processing system comprising:
a first workstation at which a first set of digital image data can be analysed to determine a first set of colour correction parameter data corresponding to colour corrections to be made to the first set of image data; a second workstation at which a second set of digital image data can be analysed to determine a second set of colour correction parameter data corresponding to colour corrections to be made to the second set of image data; and
a digital image processing module connected to the first and second workstations so as to receive correction requests containing the first and second image data sets and first and second colour correction parameter data sets respectively from the first and second workstations, wherein the digital image processing module comprises a programmable logic device.

2. A digital image processing system comprising:
data connection means for connection to a plurality of workstations at which respective digital image data can be analysed to determine respective sets of colour correction parameter data corresponding to colour corrections to be made to the image data; and
a digital image processing module connected to the data connection means so as to receive correction requests containing the respective image data sets and the respective colour correction parameter data sets, wherein the digital image processing module comprises a programmable logic device.

3. A digital image processing system as claimed in claim 1, wherein the programmable logic device is made up of a number of gates or logic cells, groups of which can be programmed to carry out different processing functions.

4. A digital image processing system as claimed in claim 1, further comprising a controller for controlling the order in which correction requests received from the respective workstations are processed at the digital image processing module.

5. A digital image processing system as claimed in claim 4, wherein the controller is configured to analyse the digital image data and the colour correction parameter data received from each work station and to determine whether or not all of the corrections can be carried out together in real time by the digital image processing module.

6. A digital image processing system as claimed in claim 5, the controller being adapted to determine which sets of image data should be processed before others where not all of the corrections can be carried out together in real time by the digital image processing module.

7. A digital image processing system as claimed in claim 6, the system further being configured to prioritise certain corrections to determine which sets of image data should be processed first.

8. A digital image processing system as claimed in claim 7, wherein all correction requests being forwarded by a particular work station take priority over data from the other work stations.

9. A digital image processing system as claimed in claim 7, wherein all correction requests relating to a particular film or job take priority over other image data, irrespective of the workstation from which the image data is received.

10. A digital image processing system as claimed in claim 7, wherein corrections to be carried out are prioritised based on a combination of the workstation from which they are received and the film or job to which they relate.

11. A digital image processing system as claimed in claim 4, wherein the controller is programmed to sort all the received correction requests which have not yet been processed according to their priority.

12. A digital image processing system as claimed in claim 11, wherein the controller is further configured to schedule the processing of the correction requests by balancing the priority of the requests against the available processing power in the programmable logic device for the requested correction.

13. A digital image processing system as claimed in claim 4, wherein the gates or logic cells may be reprogrammed by the controller to carry out a different type of colour correction depending on the corrections requested by the various workstations.

14. A digital image processing system as claimed in claim 1, wherein the programmable logic device comprises one or more Field Programmable Gate Arrays (FPGAs).

15. A digital image processing system as claimed in claim 14, wherein the image processing module comprises four FPGAs connected together, and the controller comprises a fifth FPGA connected to each of the other four FPGAs.

16. A method of processing digital image data using the system as claimed in claim 1.

17. A method of processing digital image data comprising the steps of receiving a plurality of image data correction requests concurrently at an image processing module, analysing the image data correction requests to determine whether or not they can all be processed concurrently in real time and determining the order in which the requests should be processed if the requests cannot all be processed concurrently in real time.

18. A digital image processing system as claimed in claim 2, wherein the programmable logic device is made up of a number of gates or logic cells, groups of which can be programmed to carry out different processing functions.

19. A digital image processing system as claimed in claim 2, further comprising a controller for controlling the order in which correction requests received from the respective workstations are processed at the digital image processing module.

20. A digital image processing system as claimed in claim 19, wherein the controller is configured to analyse the digital image data and the colour correction parameter data received from each work station and to determine whether or not all of the corrections can be carried out together in real time by the digital image processing module.

21. A digital image processing system as claimed in claim 20, the controller being adapted to determine which sets of image data should be processed before others where not all of the corrections can be carried out together in real time by the digital image processing module.

22. A digital image processing system as claimed in claim 21, the system further being configured to prioritise certain corrections to determine which sets of image data should be processed first.

23. A digital image processing system as claimed in claim 22, wherein all correction requests being forwarded by a particular work station take priority over data from the other work stations.

24. A digital image processing system as claimed in claim 22, wherein all correction requests relating to a particular film or job take priority over other image data, irrespective of the workstation from which the image data is received.

25. A digital image processing system as claimed in claim 22, wherein corrections to be carried out are prioritised based on a combination of the workstation from which they are received and the film or job to which they relate.

26. A digital image processing system as claimed in claim 19, wherein the controller is programmed to sort all the received correction requests which have not yet been processed according to their priority.

27. A digital image processing system as claimed in claim 26, wherein the controller is further configured to schedule the processing of the correction requests by balancing the priority of the requests against the available processing power in the programmable logic device for the requested correction.

28. A digital image processing system as claimed in claim 19, wherein the gates or logic cells may be reprogrammed by the controller to carry out a different type of colour correction depending on the corrections requested by the various workstations.

29. A digital image processing system as claimed in claim 2, wherein the programmable logic device comprises one or more Field Programmable Gate Arrays (FPGAs).

30. A digital image processing system as claimed in claim 29, wherein the image processing module comprises four FPGAs connected together, and the controller comprises a fifth FPGA connected to each of the other four FPGAs.
